(19) United States
(12) Patent Application Publication
(10) Pub. No.: US 2014/0250932 A1
(43) Pub. Date: Sep. 11, 2014

(54) PORTABLE HEAT EXCHANGE COOLER

(71) Applicants: Valdemar A. Martinez, JR., Laredo, TX (US); Alan R. Reeb, Three Rivers, TX (US); Terry L. Reeb, Victoria, TX (US)

(72) Inventors: Valdemar A. Martinez, JR., Laredo, TX (US); Alan R. Reeb, Three Rivers, TX (US); Terry L. Reeb, Victoria, TX (US)

(21) Appl. No.: 13/785,469

(22) Filed: Mar. 5, 2013

(51) Int. Cl. B60H 1/32

(52) U.S. Cl. CPC B60H 1/32
USPC 62/239

(57) ABSTRACT

A portable heat exchange cooler with a self-contained heat exchange unit configured for cost-effective transportation without wide-load travel restrictions to remote locations. The portable heat exchange cooler can include a process cooler, an engine driver, and a fuel vessel, each mounted on a gooseneck-style trailer. The process cooler is typically housed within a containment cage and configured to reduce the temperature of a gas flowing through cooling tubes of the process cooler. An engine driver typically housed outside the containment cage can drive the process cooler. The engine driver is coupled to a fuel vessel capable of providing fuel for powering the engine driver. Leveling devices positioned on the trailer are useful for leveling the trailer (and the process cooler) at a field site.

### FIELD OF INVENTION

This disclosure relates generally to a technical field of gas and liquid cooling and, in one example embodiment, to a system, method and an apparatus for a portable heat exchange cooler.

### BACKGROUND

Process coolers may be used to reduce the temperature of gases or liquids by heat exchange operations. For example, process coolers may be used to cool natural gas.

Typically, extraction or treatment of natural gas may include cooling the natural gas prior to transmission or storage of the natural gas. The natural gas may have to be cooled in order to reduce volatility of the natural gas or to meet pipeline specifications. Such cooling operations may be performed by large process coolers installed at a field site.

Conventional process coolers may be subject to transportation regulations when transported by a trailer, because they are deemed as “wide loads” based on their size and weight. Further, the trailer deemed as “wide load” may have to be accompanied by one or more escort vehicles to transport the process cooler to the field site. In addition, at the installation site, heavy machinery such as cranes may be used to move the process cooler from the trailer to a concrete skid. The transportation and installation activities for such conventional process coolers may be cumbersome, cost intensive, and time-consuming. Further, conventional process coolers may be installed on the concrete skid at the field site which may cause the process cooler to be directly exposed to radiated heat from the concrete pad. Such direct and intense exposure to the radiated heat from the concrete skid may reduce an efficiency of the process cooler. Thus, there is a need for process cooler technology to overcome the shortcomings of a conventional process cooler.

### SUMMARY

In an example embodiment, a portable cooler system includes a process cooler mounted on a gooseneck trailer that has leveling members to permit level installation of the gooseneck trailer (and the process cooler) at a field site. The process cooler mounted on the gooseneck trailer can be housed within a containment cage and can operate to change the temperature of gas passing through the process cooler. For example, the process cooler can operate as a heat-exchanger to cool the temperature of a gas passing through the process cooler. One of ordinary skill in the art can understand and appreciate that in other example embodiments the process cooler can be operated to change temperature of a liquid, or a combination of a liquid and gas passing through the process cooler without departing from the broader scope of this disclosure.

An exemplary process cooler can be implemented by an F-style cooler. A representative process cooler includes a cooling tube and an inlet flange and an outlet flange coupled to ends of the cooling tube. The cooling tube is typically adapted to carry natural gas. One of ordinary skill in the art can understand and appreciate that the cooling tube can be adapted to carry other gaseous matter, liquids or a combination of both, in other example embodiments. The cooling tube can be positioned at a top portion of the process cooler and arranged in a serpentine manner, wherein the cooling tube is oriented along an axis horizontal to the process cooler. A propeller fan can be coupled to a front portion of the process cooler to provide a forced-air motion across the cooling tube for the heat exchange operation. An exemplary configuration for the propeller fan is a whisper-quiet fan with six fan blades for efficient, reduced noise fan operations. The flow of forced-air motion can be directed in a substantially perpendicular direction within the process cooler for exit at the cooler's top portion and away from the engine driver. A louver can be positioned substantially at the top portion of the process cooler to output forced-air after the heat exchange operation.

Further, the portable cooler system includes an engine driver mounted on the gooseneck trailer. The engine driver can be placed outside the containment cage and can be coupled to the process cooler. The engine driver can operate to drive the propeller fan of the process cooler.

In addition, the portable cooler system includes a fuel vessel mounted on the gooseneck trailer and positioned outside the containment cage. The fuel vessel can be coupled to the engine driver and can provide fuel that can be used to support the operations of the engine driver. Further, the fuel vessel can be coupled to an external fuel source to receive fuel that can be used to support the operations of the engine driver. Additionally, the fuel vessel can include a mechanism to maintain predetermined fluid levels and safe fuel pressure levels within the fuel vessel. The portable cooler system can further include an oil vessel housed within the containment cage. The oil vessel can store lubricant agents that can be used for smooth operation of the engine driver. Further, a separator can be mounted to the gooseneck trailer to support a separation of fluids from an output of the process cooler.

The foregoing discussion of the portable heat exchange cooler is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, and objects of the present invention will become apparent to one with skill in the art upon examination of the following drawings and detailed description. It is intended that all such aspects, systems, methods, features, advantages, and objects are to be included within this description, are to be within the scope of the present invention, and are to be protected by the accompanying claims.

### BRIEF DESCRIPTION OF THE DRAWINGS

Example embodiments are illustrated by way of example and not limitation in the figures of the accompanying drawings, in which:

FIG. 1 illustrates a perspective view of a portable heat exchange cooler, according to certain exemplary embodiments of the present invention.

FIG. 2 illustrates a side elevation view of one side of the portable heat exchange cooler, according to certain exemplary embodiments of the present invention.

FIG. 3 illustrates a side elevation view of another side of the portable heat exchange cooler, according to certain exemplary embodiments of the present invention.

FIG. 4 illustrates an overhead plan view of the portable heat exchange cooler, according to certain exemplary embodiments of the present invention.

FIG. 5 illustrates a back perspective view of the portable heat exchange cooler, according to certain exemplary embodiments of the present invention.

FIG. 6 illustrates a front perspective view of the portable heat exchange cooler, according to certain exemplary embodiments of the present invention.

FIG. 7 illustrates a perspective view of a process cooler of the portable heat exchange cooler, according to certain exemplary embodiments of the present invention.

FIGS. 8A, 8B, and 8C (collectively FIG. 8) are flow charts that illustrate a process of operation of the portable heat exchange cooler, according to certain exemplary embodiments of the present invention.

FIG. 9 is a flow chart that illustrates a process of operation of the engine driver start-up, according to certain exemplary embodiments of the present invention.

Many aspects of the invention can be better understood with reference to the above drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views. Other features of the present embodiments will be apparent from the Detailed Description that follows.

### DETAILED DESCRIPTION

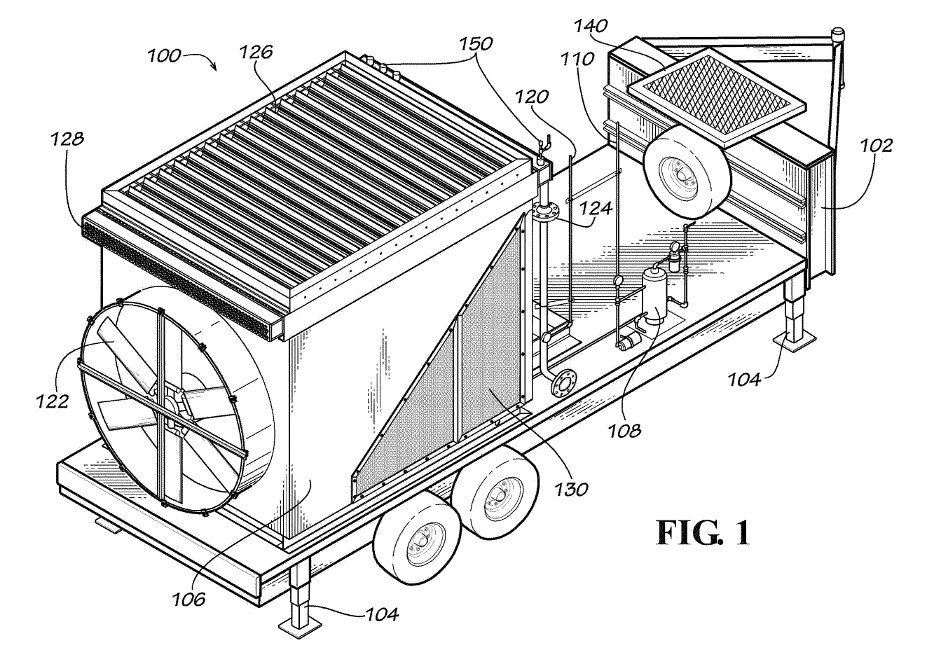

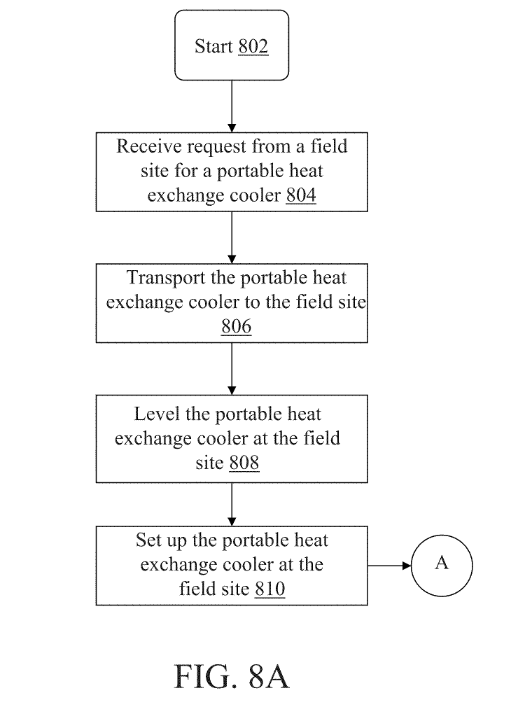

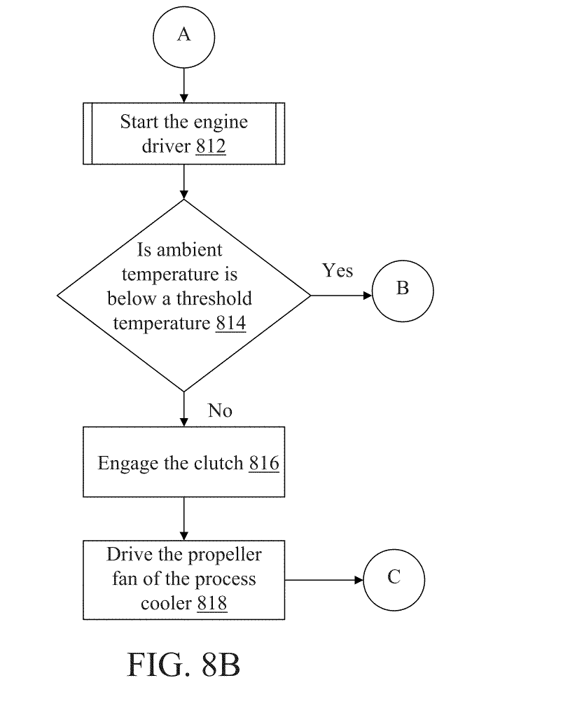

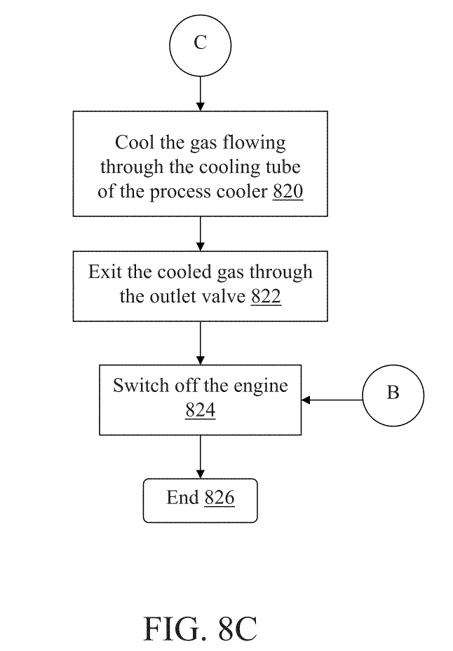

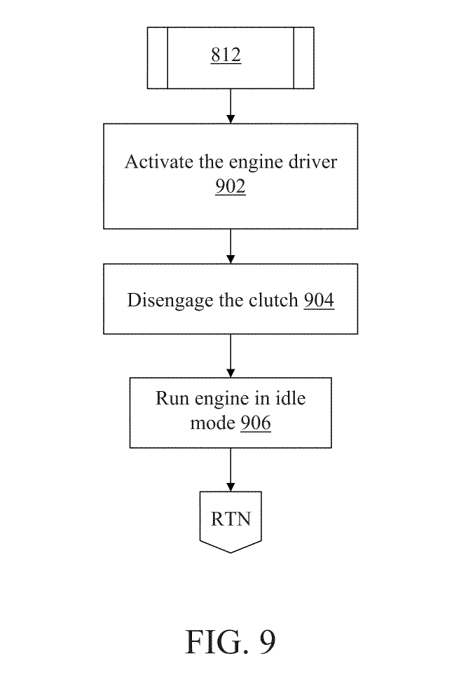

A portable heat exchange cooler will now be described in greater detail with reference to FIGS. 1-9, which describe representative embodiments of the present invention. FIGS. 1-7 describe the portable heat exchange cooler system with reference to different perspective views of the portable heat exchange cooler using suitable illustrations. FIGS. 8 and 9 describe the operation of the portable heat exchange cooler using suitable flowcharts.

For an exemplary embodiment, a portable heat exchange cooler comprises a process cooler mounted to a trailer, typically gooseneck-type trailer, for use in heat exchange operations at a natural gas processing field site. The combination of a reduced weight, low-height process cooler with a gooseneck-type trailer permits transportation of the cooler system to a field site by a vehicle that is not required to comply with “wide-load” transportation regulations. The gooseneck-type trailer has front and rear leveling jacks to permit level installation of the cooler system at a field site without placement of the cooler system on a concrete skid or pad. A natural gas processor can achieve efficient and cost-effective cooling operations at a field site by transporting the trailer-mounted cooler system to a field site, leveling the trailer with the leveling jacks, connecting the cooler to a fuel source and natural gas lines and starting cooler operations. The exemplary process cooler, typically an F-style cooler, is mounted within a containment cage on the trailer. An engine driver, positioned outside of the containment cage, can drive the process cooler. The engine driver is typically separated from the process cooler to minimize exposure to heat exhaust resulting from heat exchange operations of the process cooler.

The process cooler can use a six-bladed propeller fan at the front of the process cooler to direct forced-air across cooling tubes that support heat exchange operations. The flow of forced-air can be directed substantially perpendicular to the process cooler and exits the process cooler via louvers. In this manner, the forced air, which can be heated during conventional heat exchange operations, is directed away from the engine driver. The propeller fan is preferably implemented by a reduced noise fan referred to as a “whisper quiet” fan for noise reduction during field site operations of the cooling system.

A fuel vessel, positioned outside of the containment cage and mounted to the trailer, can provide on-board fuel level (e.g., pressure and fluid level) maintenance for safe operations. The fuel vessel may receive fuel from an external source outside the gooseneck trailer (e.g., at field site) and direct the fuel to the engine driver. As the fuel passes through the fuel vessel to the engine driver, the fuel vessel may maintain a fluid level within the fuel vessel at a safe level. In an example embodiment, the fuel vessel may include a floating element. As the liquid level in the fuel vessel rises, the floating element rises along with the liquid level and as the floating element passes a predetermined marker level in the fuel vessel, the fuel input to the fuel vessel (from the external source) or the fuel output to the engine driver can be cut off. Further, the fuel vessel can include a mechanism to maintain a predetermined level of pressure within the fuel vessel, i.e., when the pressure with the fuel vessel increases above a predetermined pressure value, the excess pressure may be relieved through a fuel relief vent. Further, an oil vessel, positioned inside the containment cage and mounted to the trailer, can provide on-board storage for a lubrication agent for the engine driver.

In an example embodiment, responsive to receiving a request for the portable heat exchange cooler at a natural gas processing site in the field, the trailer mounted with the process cooler can be hitched to a vehicle, such as a truck and transported to the field site. Once the trailer is brought to the field site, the trailer can be rested on a leveled and/or compacted ground at the field site. In some embodiments, the trailer may be rested on a concrete pad or any other type of pad, if such a pad is available to the field site. Further, the trailer may be unhitched from the vehicle. Once the trailer is unhitched and rested, the trailer can be further leveled using leveling jacks as desired. After leveling the trailer, the process cooler that is mounted on the trailer may be set up to receive gas (e.g., natural gas, or any other appropriate gaseous matter) that needs to be cooled. Once set-up, natural gas may flow through the process cooler that is driven by the engine driver, wherein the process cooler is operable to reduce a temperature of the gas flowing through the process cooler. Further, the cooled gas can exit the process cooler for distribution to a desired destination.

The present invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting and among others supported by representations of the present invention. In the following description, for purposes of explanation, numerous specific details are set forth in order to provide a thorough understanding of the various embodiments.

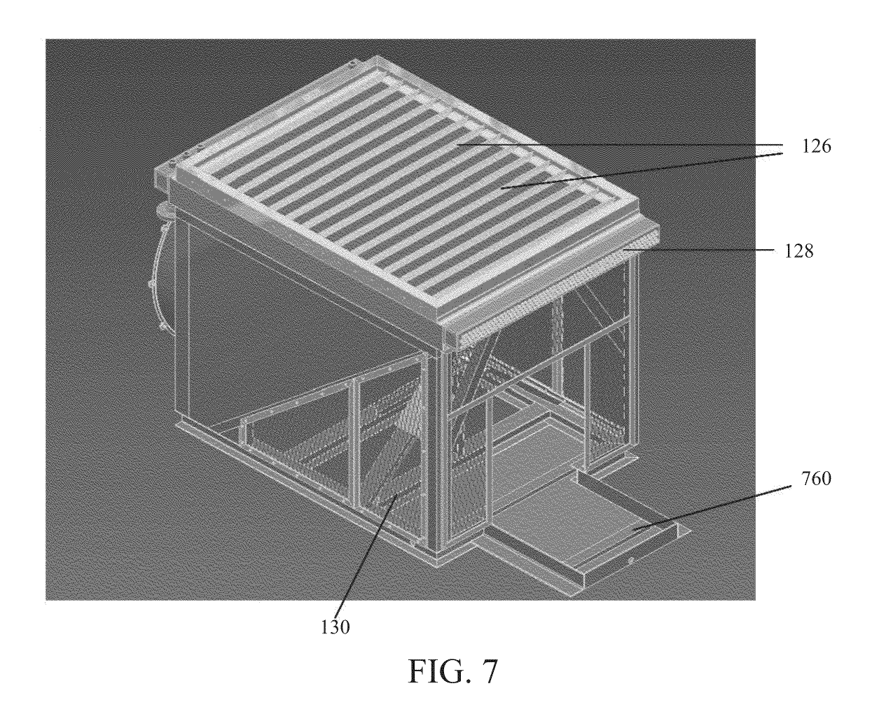

Referring now to FIGS. 1-7, these figures illustrate perspective views of exemplary components for a portable heat exchange cooler system, according to certain exemplary embodiments of the present invention. In particular, FIGS. 1-6 illustrate a gooseneck trailer 102, leveling jacks 104, an enclosure 106, a fuel vessel 108, a fuel relief vent 110, manual blow down vent 120, a propeller fan 122, inlet/outlet flanges 124, louvers 126, cooling tube 128, belt and clutch guards 130, a solar panel 140, cooler relief vent 150, engine driver 202, a digital panel 208, a process cooler 204, an oil vessel 206, an idler assembly 210, and a propeller fan drive shaft 212. Further, FIG. 7 specifically illustrates a drip container 760.

### Gooseneck Trailer

FIG. 1 illustrates a perspective view of the portable heat exchange cooler, according to certain exemplary embodiments of the present invention. As depicted in FIG. 1, the portable heat exchange cooler system 100 may be configured on a gooseneck trailer 102. The gooseneck trailer 102 may provide easy maneuverability in tight spaces. In an example embodiment, the gooseneck trailer 102 may be a 20 foot, gooseneck trailer, which may be towed by a 1 ton truck. One of ordinary skill in the art can understand and appreciate that even through the present embodiment describes a gooseneck trailer, the portable heat exchange cooler system may be configured on any other functionally equivalent trailer and may be towed by any other appropriate vehicle. For example, the gooseneck trailer 102 can be replaced by a flatbed trailer, subject to the possible application of wide load transportation requirements and weight limitations to this replacement trailer.

The gooseneck trailer 102 may include one or more leveling jacks 104 configured at a front end and a rear end of the trailer. The one or more leveling jacks 104 may be used to level the trailer bed on which the portable heat exchange cooler 100 is configured. Further, the one or more leveling jack 104 may be used to raise or lower the gooseneck trailer 102 as desired. In addition, the gooseneck trailer 102 can include a coupling assembly to hitch the gooseneck trailer 102 to a vehicle, such as a truck, for transporting the gooseneck trailer 102 to a field site.

At a field site, the gooseneck trailer 102 can be rested on leveled or compacted ground. In another embodiment, the gooseneck trailer 102 can be rested on a pad, such as a concrete pad at the field site provided the facilities at the field site include a pad. In yet another embodiment, if a pad is not available, the gooseneck trailer can be rested on ground which may be compacted and level or on ground that may not be level. Once the gooseneck trailer 102 on which the portable heat exchange cooler 100 is mounted is rested, the gooseneck trailer 102 can be leveled as required, by adjusting the leveling jacks 104 as described above. The leveling jacks 104 may permit a level installation of the portable heat exchange cooler 100 without placing the cooler 100 on a concrete skid or pad. After leveling, the portable heat exchange cooler 100 may be set-up to receive gas that requires cooling in connection with gas processing operations. The set-up process may include coupling a process cooler 204 to a gas pipeline/input pipe that carries the gas that is to be cooled. Coupling the process cooler 204 to the gas pipeline/input pipe can include coupling the gas pipeline to the inlet/outlet flange 124 of the process cooler 204. Further, the gas pipeline may be coupled to an inlet of the fuel vessel 108, if the gas that is to be cooled is the same gas that is used as fuel for the engine driver 202. However, the gas supplied to the fuel vessel 108 and thereby to the engine driver 202 may be dehydrated by dehydrator at the field site. If the dehydrated gas has any residual fluid, some of the fluid can get disposed in the fuel vessel. To account for such fluid, the fuel vessel 108 may include a mechanism to prevent a rise of fluid level within the fuel vessel 108 beyond a predetermined level. Once the portable heat exchange cooler 100 is set-up, the process cooler 204 may be activated for operation and when activated, the process cooler 204 can cool gas flowing through the process cooler 204 by a heat exchange process, such as forced air cooling. Further, the cooled gas may be sent out of the process cooler 204 through an outlet pipe or output pipeline. One of ordinary skill in the art can understand and appreciate that the forced air cooling method as described herein can be replaced by any other appropriate cooling method without departing from the broader spirit of the present disclosure.

The portable heat exchange cooler system 100 may be operated while mounted on the gooseneck trailer 102 i.e., the portable heat exchange cooler system 100 need not be dismounted from and mounted back on to the gooseneck trailer 102 at the field site for operational purposes.

In an example embodiment, the combined height, measure from the ground, of the gooseneck trailer 102 and the portable heat exchange cooler system 100 mounted on the gooseneck trailer 102 may be less than or equal to 13.6 feet. Consequently, the portable heat exchange cooler system 100 can be transported on the gooseneck trailer 102 without having any additional road permits, oversized or wide-load load restrictions and escort vehicles.

### Enclosure/Containment Cage

As depicted in FIG. 1-3, the process cooler 204 may be placed within a containment depicted as enclosure or containment cage 106 mounted to the gooseneck trailer 102. The enclosure 106 may be described in greater detail below, in association with FIGS. 1-3 and FIG. 7.

Turning now to FIG. 7, FIG. 7 illustrates a perspective view of a process cooler of the portable heat exchange cooler, according to certain exemplary embodiments of the present invention. As depicted in FIG. 7, the enclosure 106 may be shaped as a cuboid. Further, the cuboid shaped enclosure 106 may have two side walls, a top wall, a bottom wall, a front wall, and a back wall. One or ordinary skill in the art can understand and appreciate that the enclosure can have any other appropriate shape without departing from the broader spirit of the disclosure. Further, one of ordinary skill in the art can understand and appreciate that the term containment cage and enclosure may be interchangeably used without departing from the broader spirit of this disclosure.

Each side wall of the enclosure 106 may include belt and clutch guards 130. In one embodiment, the belt and clutch guards 130 may be bolt on steel guards. In another embodiment, the belt and clutch guards 130 may be made of aluminum. Further, the belt and clutch guards 130 can be removed and fitted back on for maintenance of the belt and clutch.

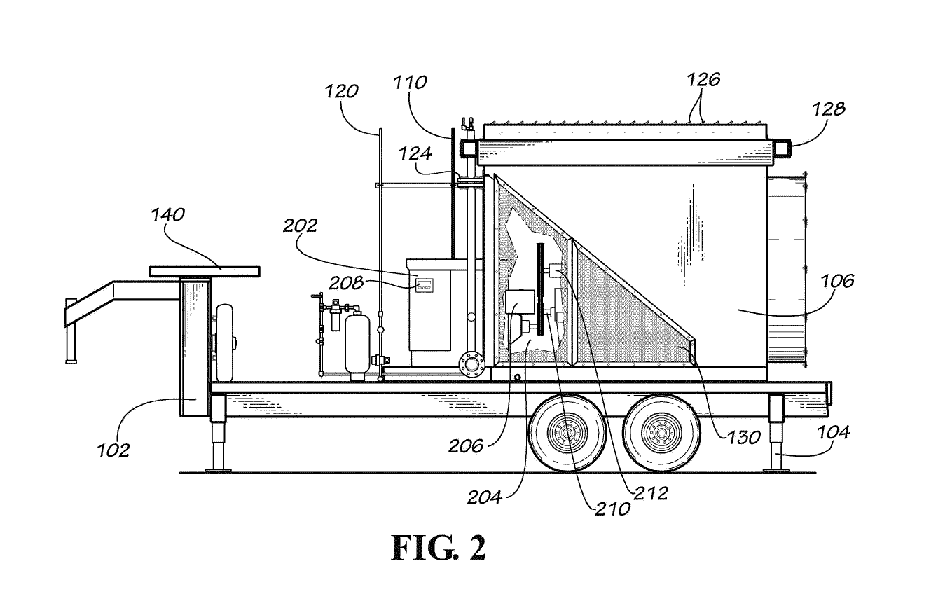

A top wall of the enclosure 106 can include a louvered opening. The louvered opening can include adjustable louvers 126. The louvers 126 may be adapted to be adjusted automatically or manually, wherein the adjustment of the louvers 126 can control air flow through the process cooler 204. For example, to increase the air flow through the process cooler 204, the louvers 126 can be fully opened. In addition to the louvered opening, the top end of the enclosure 106 can include cooler relief vent and inlet/outlet shutdown valves 150 which will be described in greater detail below, in association with FIGS. 2-6.

Further, a bottom wall of the enclosure 106 may include a drip container 760 which may extend further beyond a rear wall of the enclosure 106 as depicted in FIG. 7. In an example embodiment, the drip container 760 within the enclosure may be adapted to hold an oil vessel 206 and the extension of the drip container 760 beyond the rear wall of the enclosure 106 may be adapted to hold an engine driver 202. A front wall of the enclosure 106 may be more clearly depicted in FIGS. 1-3.

Turning back to FIGS. 1-3, the front wall of the enclosure 106 may include an enclosure for a propeller fan 122 that is used to create an air flow by suction of air from the atmosphere into the process cooler 204. The air flow created by fan operations is useful for the cooling the gas flowing through a cooling tube 128 of the process cooler 204. In an example embodiment, the enclosure for the propeller fan 122 can be an extension of the enclosure 106 for the process cooler 204. In one embodiment, the shape of the enclosure for the propeller fan 122 can be substantially the same shape of the propeller fan 122.

In one embodiment, the enclosure 106 may be adapted such that an air flow generated via the propeller fan 122, by suction of air into the enclosure 106 can be directed substantially vertically to the louvered opening at the top wall of the enclosure 106 for exit at the top of the process cooler (away from other components of the cooler system). In other words, the air flow may be directed away from the back wall of the enclosure and consequently away from the engine driver 202 that is housed near the back wall of the enclosure 106. In another embodiment, even ambient air flow (e.g., natural air flow) i.e., air flow that is not generated by the propeller fan 122 may be directed substantially vertically to the louvered openings at the top wall of the enclosure.

In an example embodiment, the enclosure 106 can be made from aluminum. One of ordinary skill in the art can understand and appreciate that in other embodiments the enclosure 106 can be made of other materials without departing from the broader scope of the disclosure.

In one or more exemplary embodiments, the enclosure 106 may house the process cooler 204, the oil vessel 206 and other additional features that provide operational support to the process cooler 204. The oil vessel 206 may be configured to store oil and provide a source of oil lubrication for the engine driver 202. The process cooler 204 is explained in greater detail in the following paragraphs.

### Process Cooler

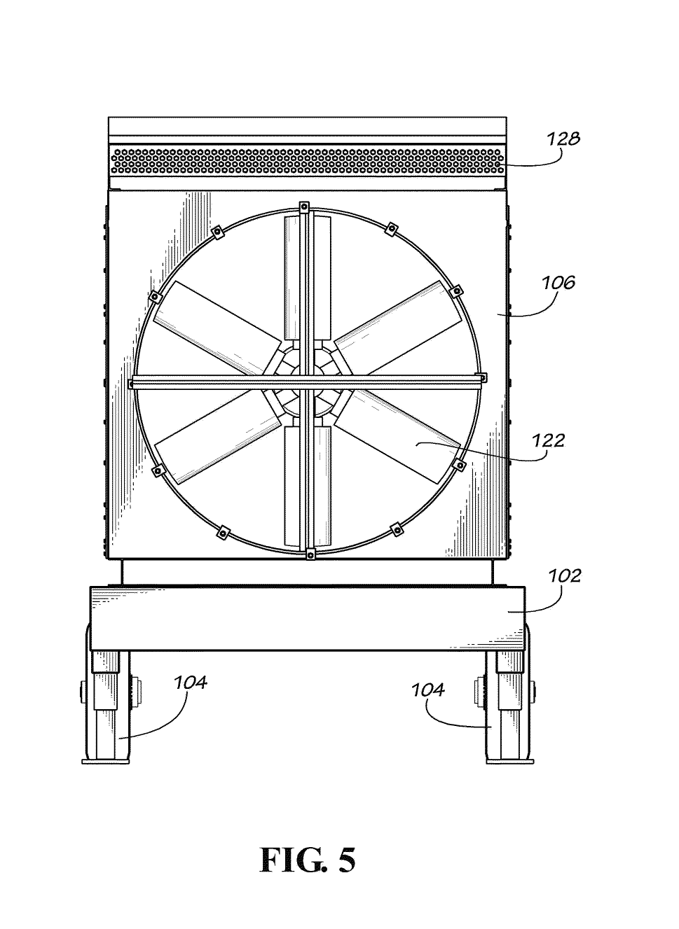

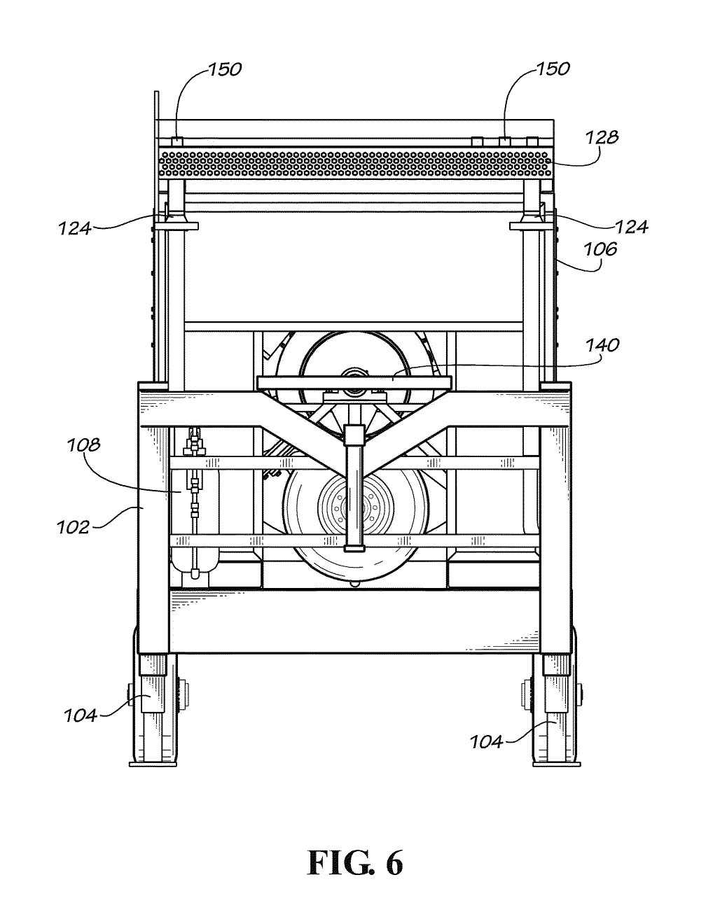

Turning now to FIGS. 5 and 6, FIGS. 5 and 6 illustrate a back perspective view and a front perspective view of the portable heat exchange cooler respectively, according to certain exemplary embodiments of the present invention. As depicted in FIGS. 5-6, the process cooler 204 can include an n-row n-pass gas cooling tube 128 that is arranged near the top wall of the enclosure 106, wherein the ‘n’ may be at least five. One of ordinary skill in the art can understand and appreciate that in some embodiments ‘n’ may be less than five. In one embodiment, the cooling tube 128 may be one single piece of tube that may be molded as n-rows having n-passes. In another embodiment, the n-row, n-pass cooling tube 128 may be formed from a combination of a number of tubes. The cooling tube 128 may be arranged as a tubular coil which is configured in a highly oscillating or serpentine manner as multiple passes in multiple rows, wherein each row is stacked on top of the other. In addition, the cooling tube 128 may be oriented horizontally along the axis of the top wall of the enclosure 106. In some embodiments, the cooling tube 128 may be oriented along multiple axes that are parallel to the axis of the top wall of the enclosure 106. In an example embodiment, a five-pass cooling tube 128 may be arranged near the top wall of the enclosure 106 and substantially parallel to the axis of the top wall of the enclosure 106. Further, the cooling tube 128 may be adapted to carry gases having high temperature.

Once gas enters the cooling tube 128, the gas may make multiple passes from a front end of the enclosure 106 to a rear end of the enclosure 106 through the entire length of the cooling tube 128 that is arranged as tubular coils as described above. As the gas proceeds through a single pass through the coils of the cooling tube 128 it decreases in temperature until it reaches the outlet where it is directed via an inlet/outlet flange 124 to a DOT pipeline or a sales facility. The cooling tube 128 may include a single inlet coupled to an inlet/outlet flange 124 and a single outlet coupled to another inlet/outlet flange 124 as depicted in FIG. 1 and FIG. 6. In one example embodiment, the enclosure 106 may be designed such that the inlet and outlet flange 124 are arranged near the top wall at a back end of the enclosure 106 that is on the opposite side of the propeller fan 122 as illustrated in FIGS. 1-6. In another example embodiment, the enclosure 106 may be designed such that the inlet and outlet flange 124 may be arranged near the top wall at a front end of the enclosure 106 that is on the same side of the propeller fan 122 as illustrated in FIG. 7.

By way of an example, gas from a gas source, such as a wellhead, may be diverted into the cooling tube 128 through an inlet/outlet flange 124 that is adapted to be directly or indirectly coupled to a gas pipeline. Further, the other inlet/outlet flange 124 may be coupled to another pipeline that carries the gas exiting from the cooling tube 128 after the gas has been subjected to a heat exchange process. In other words, the gas that has been cooled may exit the cooling tube 128 through the other inlet/outlet flange 124.

Further, the process cooler 204 may include a manual blow down vent 120. In some embodiments, the process cooler 204 may have to be purged or relieved of any energy within the process cooler. To purge the process cooler 204, first an inlet/outlet to the process cooler 204 may be closed. Responsive to closing the inlet/outlet to the process cooler 204, the process cooler 204 may be cut off from the gas coming into and gas leaving the process cooler 204, but there may be residual energy in the process cooler 204. So, once the inlet/outlet is closed, the manual blow down vent 120 may be opened to purge the process cooler 204 of any residual energy.

In addition to the manual blow down vent 120, the process cooler 204 can include a cooler relief vent 150. The cooler relief vent may include a cooler relief valve. In an example embodiment, the cooler relief valve may be set to be actuated at 1,440 psi i.e., if the pressure in any of the inlet/outlet pipeline increases above 1,440 psi, the cooler relief valve may open and the excess pressure may be relieved through the cooler relief vent 150, thereby preventing the pipeline from over pressuring the process cooler 204. In other words, the cooler relief vent 150 may be used to relieve any excess pressure from the inlet/outlet pipeline when the pressure of gas inside the inlet/outlet pipeline exceeds a threshold pressure limit. In an example embodiment, the gas (or liquid) released through the manual blow down vent 120 or the cooler relief vent 150 can be captured by piping them to a desired destination or piping them back to the process cooler 204/fuel vessel 108/engine driver 202. In some embodiments, the captured residual gas (or liquid) released through the manual blow down vent 120 or cooler relief vent 150 can be stored at a desired destination for any further application.

Further, the process cooler 204 may include a propeller fan 122 that when operational, can create an air flow through the suction of air from the atmosphere into the process cooler 204 as described above. In one embodiment, the process cooler 106 may be an F-style cooler where the air flow is directed from the front wall of the enclosure 106 substantially vertically towards the top end of enclosure 106. One or ordinary skill in the art can understand and appreciate that even though an F-style cooler is described herein, the F-style cooler may be replaced by any appropriate functionally equivalent cooler without departing from the broader spirit of the disclosure.

As described above, the enclosure 106 may be designed such that, once the air from the atmosphere is sucked into the process cooler, the direction of the air flow may be diverted away from the rear wall of the enclosure 106 and vertically towards the louvered openings at the top wall of the enclosure 106. As air from the atmosphere is directed towards the top wall of the enclosure 106, the air can pass over the cooling tubes 128 that carry gas at a high temperature. Provided the air flowing over the cooling tube 128 is at a lower temperature than the temperature of the gas in the cooling tube, heat may be exchanged from the gas in the cooling tube to the air flowing over the cooling tube thereby cooling the gas in the cooling tube 128.

The propeller fan 122 may be an n-blade fan; wherein ‘n’ may be at least six. One of ordinary skill in the art can understand and appreciate that in some embodiments, ‘n’ may be less than six. In one embodiment, the number of blades in the propeller fan 122 can be increased to increase the amount of air that the propeller fan moves, represented as cubic feet per minute (CFM). The propeller fan as depicted in FIG. 7 may be driven by an engine driver 202. The engine driver 202 and the operation of the engine driver 202 may be described in further detail below, in association with the FIGS. 1-6 which illustrate various perspective views of the engine driver 202 on the gooseneck trailer 102.

### Engine Driver

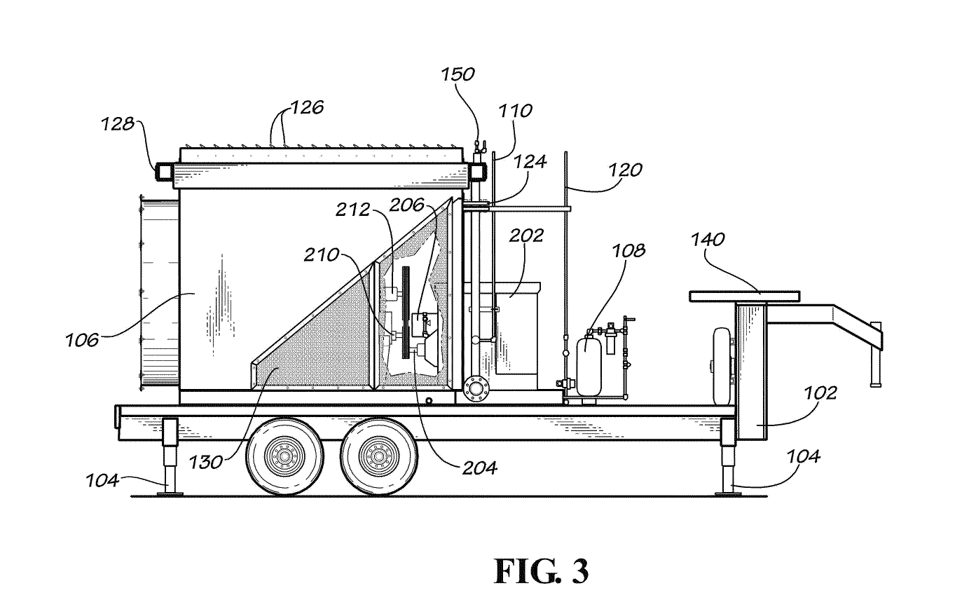

Turning now to FIGS. 2 and 3, FIGS. 2 and 3 illustrate a side elevation view of one side of the portable heat exchange cooler and a side elevation view of the other side of the portable heat exchange cooler respectively, according to certain exemplary embodiments of the present invention. As depicted in FIGS. 2 and 3, the engine driver 202 can be placed outside the enclosure 106 over the drip containment 760 (shown in FIG. 7) and coupled to the process cooler 204. The engine driver 202 can be configured to drive the propeller fan's drive shaft 212 and thereby the propeller fan 122 to cool a gas flowing through the cooling tube 128 of the process cooler 204. In one embodiment, the engine driver 202 can run on gaseous fuel. For example, natural gas that is to be cooled by the process cooler 204 may be used as fuel for operations of the engine driver 202 (in dehydrated form). In other embodiments, the engine driver 202 may run on electric energy or liquid fuel. The type of engine driver 202 may be chosen based on the operational environment, application of the portable heat exchange cooler 100, and/or power requirements for the application of the portable heat exchange cooler 100. Further, one of ordinary skill in the art can understand that the engine driver may be chosen subject to the possible application of wide load transportation requirements and weight limitations. In an example embodiment, the engine driver 202 may include an I-4 engine. One of ordinary skill in the art can understand and appreciate that the I-4 engine can be replaced by any other appropriate engine that can drive the process cooler 204 without departing from the broader scope of the present disclosure. The engine driver 202 may be coupled to process cooler 204 and, in addition, adapted to drive the propeller fan 122.

The engine driver 202 may include a clutch assembly to transfer power from the engine driver to the process cooler 204. In one embodiment, the clutch assembly may include a shaft coupled to the engine driver, a propeller fan's drive shaft 212, one or more pulleys, a belt drive, and an idler assembly to tension the belt drive. Once the engine driver 202 is operational, the idler assembly 210, the propeller fan's drive shaft 212, the pulleys, the belt drive assembly, and the shaft coupled to the engine motor may operate in concert to drive the propeller fan 122 of the process cooler 204. However, when the propeller fan 122 needs to be stopped operationally, the clutch can be disengaged. Disengaging the clutch may put the engine in an idle mode where the engine is operational, but the power from the engine driver may be not transferred to the propeller fan 122 of the process cooler 204.

In addition to the clutch assembly, the engine driver 202 may include a digital display board 208 and an electronic control circuit as depicted in FIG. 3. The engine driver 202 can be configured to be operated and controlled using the electronic control circuits. The engine driver 202 can be controlled by the electronic control having an electronic fuel control that starts when the engine is in idle mode. Other example features that can be controlled using the electronic control circuitry can include speed of the engine, safety parameters of the engine, oil level, and water temperature.

In further embodiments, the engine driver 202 may include sensors that can provide a measure of the ambient temperature, the measure of the gas temperature inside the cooling tubes, etc.

In an example embodiment, the engine driver 202 may be powered using fuel, which may be supplied to the engine driver 202 through a fuel vessel 108. In some embodiments, the fuel vessel 108 can be configured to store fuel. The fuel vessel 108 may be described in greater detail below, in association with FIGS. 1-6, which illustrate multiple perspective views of the fuel vessel 108 on the gooseneck trailer 102.

### Fuel Vessel

As depicted in FIGS. 1-6, the fuel vessel 108 may be mounted to the gooseneck trailer 102. The fuel vessel 108 may be positioned near the front end of the gooseneck trailer 102. One of ordinary skill in the art can understand and appreciate the positional arrangement of the process cooler, engine driver and the fuel vessel can be changed appropriately. For example, the fuel vessel 108 may be configured near the rear or back end of the gooseneck trailer 102 while the enclosure 106 with the process cooler 204 may be configured at the front end of the gooseneck trailer 102. The fuel vessel 108 can direct fuel from an external source to the engine driver 202 to power the engine driver 202. The fuel passed through the fuel vessel 108 may be a hydrocarbon based fuel, such as natural gas. In an example embodiment, the fuel vessel 108 may include de-hydrated fuel furnished by the customer at the field site.

The fuel vessel 108 can be coupled to the engine driver 202 to provide fuel for operation of the engine driver 202. In another embodiment, the engine driver 202 can be adapted to be coupled to an external fuel source available at the field site. For example, a field site may have a dehydrator to provide dehydrated fuel for other equipment's at the field site and this dehydrator available at the field site can be coupled to the engine driver 202.

The fuel vessel 108 may be pressurized and pressurized fuel may be delivered from the fuel vessel 108 to the engine driver 202 via fuel lines.

In one embodiment, the fuel vessel 108 may be coupled to a fuel relief vent 110 which in turn may be coupled to a fuel relief valve that maybe set at a predetermined pressure level. The fuel relief valve may be configured to actuate and relieve pressure from the fuel vessel 108 through the fuel relief vent 110 when the pressure in the fuel vessel 108 exceeds the predetermined pressure level. In an example embodiment, the fuel relief valve may be set at 20 psi i.e., when the pressure inside the fuel vessel or the fuel lines increase above 20 psi, the fuel relief valve may be actuated to relieve a pressure inside the fuel vessel 108 or the fuel lines through the fuel relief vent 110. Further, the fuel vessel 108 can include a floating element and a marker level that determines the amount of fluid in the fuel vessel. As the fluid level in the fuel vessel 108 increases, the floating element will rise along with the fluid level and once the floating element crosses the marked level within the fuel vessel, an input to and/or output from the fuel vessel can be cutoff.

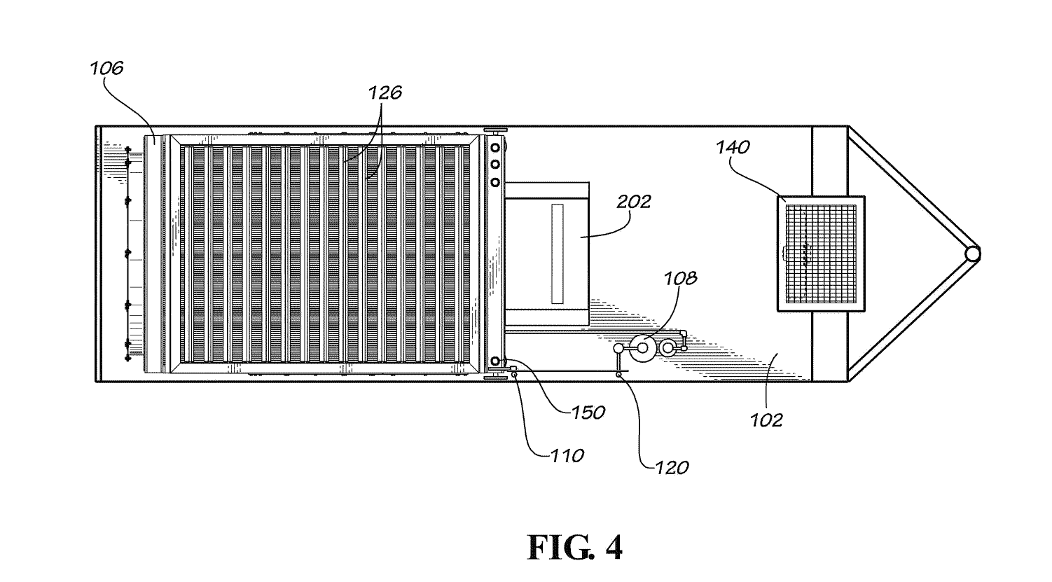

As depicted in FIGS. 1-6, the portable heat exchange cooler 100 can include the process cooler 204, the enclosure 106, the engine driver 202, and the fuel vessel 108 configured on a gooseneck trailer 102. In addition, the portable heat exchange cooler 100 can include a solar panel 140 as depicted in FIGS. 1-6 and in particular in FIG. 4. The solar panel 140 may be used to provide an alternate source of energy for any appropriate operation of the portable heat exchange cooler 100. For example, the solar panel 140 can be configured to provide an alternate energy source for charging a battery associated with operating the process cooler. Further, the portable heat exchange cooler can include a separator device (not shown in the Figures) configured on the gooseneck trailer 102 and coupled to an outlet valve of the process cooler 204. The separator device can be used to separate liquid matter from the gaseous matter at the output of the process cooler 204. The operation of the portable heat exchange cooler will be described in greater detail below, in association with FIG. 8.

Although specific operations are disclosed in the flowcharts illustrated in FIGS. 8 and 9, such operations are exemplary. That is, embodiments of the present invention are well suited to performing various other operations or variations of the operations recited in the flowcharts. It is appreciated that the operations in the flowcharts illustrated in FIGS. 8 and 9 may be performed in an order different than presented, and that not all of the operations in the flowcharts may be performed.

### Operation of the Portable Heat Exchange Cooler

Turning now to FIG. 8, FIGS. 8A, 8B, and 8C (collectively FIG. 8) is a flow chart that illustrates a process of operation of the portable heat exchange cooler, according to certain exemplary embodiments of the present invention. As described above, in an example embodiment, the portable heat exchange cooler 100 may include a process cooler 204, an engine driver 108, and/or a fuel valve 108 configured on a gooseneck trailer 102. The process cooler 204, the engine driver 202 and the fuel vessel 108 may be bolted down, securely fastened to the gooseneck trailer and ready to be transported upon request.

The process begins at operation 802 and proceeds to operation 804. In operation 804, a request for the portable heat exchange cooler 100 may be received. In an example embodiment, the request may be for cooling natural gas at a well site that may be at a remote location which may be different from the location of the portable heat exchange cooler 100. Once the request for the portable heat exchange cooler 100 is received, in operation 806, the gooseneck trailer 102 mounted with the heat exchange cooler 100 may be hitched to a vehicle, such as a pickup truck. Once the gooseneck trailer 102 is hitched to the vehicle, in operation 806, the portable heat exchange cooler may be transported to the well site that is at a remote location. One of ordinary skill in the art can understand and appreciate that since the combined height, from the ground, of the portable heat exchange cooler 100 including with the gooseneck trailer 102 is below 13.6 feet, the portable heat exchange cooler 100 may be transported with no additional road permits, an oversized load or wide-load restrictions and any escort vehicles.

Once the portable heat exchange cooler 100 is transported to the field site (e.g., requested well site), in operation 808, the gooseneck trailer 102 may be maneuvered to rest on a compacted surface, such as a concrete pad at the field site. Once the gooseneck trailer 102 is rested, the gooseneck trailer 102 may be unhitched from the vehicle. In one embodiment, the ground on which the gooseneck trailer is rested may be leveled. In another embodiment, the ground may not be leveled. If the ground or the compacted concrete pad is not leveled, in operation 808, the gooseneck trailer may be leveled using the one or more leveling jacks 104. In an example embodiment, the portable heat exchange cooler 100 may include a sensor that measures the amount of radiated heat from the ground or the pad. The sensor may be used to determine an amount of radiated heat to which the portable heat exchange cooler 100 is exposed from underneath the gooseneck trailer 102. Exposure to high amounts of radiated heat may reduce an efficiency of the cooler. Therefore, based on the sensor readings, the height of the gooseneck trailer 102 may be adjusted to minimize the exposure of the portable heat exchange cooler 100 to radiated heat from the ground underneath. For example, when the trailer bed is a couple of feet from the ground, an air gap between the trailer bed and the ground/pad may provide a cushion of 10-15 degree Fahrenheit that avoids direct exposure to radiated heat from the ground, thereby improving an effectiveness of the portable heat exchange cooler 100.

Once the gooseneck trailer 102 mounted with the process cooler 204 and supporting components is leveled, in operation 810, the portable heat exchange cooler 100 may be set up for operation. The set up process may include, but is not limited to, coupling a pipeline transporting the gas that is to be cooled to an inlet/outlet flange 124 of the process cooler 204, coupling another inlet/outlet flange 124 of the process cooler to an output pipeline for carrying the cooled gas out of the process cooler 204, and coupling the engine driver 202 to either the fuel vessel 108 or an external de-hydrated fuel source to power the engine driver 202. In some embodiments, the other inlet/outlet flange 124 of the process cooler 204 may be coupled to a separator that is configured on the gooseneck trailer 102. In other embodiments, the separator may be located at the field site. The separator may be used to separate liquids from the gas once the gas is cooled by the process cooler 204.

Once the heat exchange cooler 100 is set up, in operation 812, the engine driver 202 may be switched on. The process of starting the engine driver 202 may be described in greater detail in association with FIG. 9.

Turning to FIG. 9, FIG. 9 is a flow chart that illustrates a process of the operation of the engine driver start up, according to certain exemplary embodiments of the present invention. In operation 902, the engine driver 202 may be switched on by a activating a start button configured on the engine driver 202. One of ordinary skill in the art can understand and appreciate that the start mechanism using push button can be replaced by other manual as well as automatic start mechanisms without departing from a broader spirit of the present disclosure. Once the engine driver 202 is switched on, in operation 904, the clutch may be disengaged followed by operation 906 where the engine driver 202 may be operated in an idle mode to let the engine warm-up. Once the engine driver 202 is running in the idle mode, the process returns to operation 812 illustrated in FIG. 8.

Referring back to FIG. 8, in operation 812, the engine driver 202 may determine if the ambient temperature is below a threshold temperature. In one embodiment, the heat exchange cooler 100 may have an onboard sensor that determines the ambient temperature. The sensor may provide the readings to the engine driver 202 which may have circuitry to compare the ambient temperature reading to a threshold temperature. In another embodiment, the ambient temperature may be manually determined and compared with the threshold temperature. If the ambient temperature is below a threshold temperature, the process proceeds to operation 824 where the engine driver 202 may be left to run in the idle mode or the engine driver 202 may be manually or automatically switched off. When the ambient temperature is lower than the threshold temperature, the gas flowing through the cooling tube 128 of the process cooler 204 may be cooled even in the absence of an air flow generated by the propeller fan. Even when the propeller fan is not operated, air may flow naturally through the process cooler 204 which may cool the gas in the cooling tube 128. For example, when the ambient temperature is 40 degree Fahrenheit, the natural air flow through the process cooler 204 may cool the gas flowing through the cooling tube 128, even when the propeller fan 122 is not operated.

However, in operation 814, if the ambient temperature is determined to be higher than the threshold temperature, the process may proceed to operation 816. In operation 816, the clutch may be engaged to transfer power from the engine driver 202 to the process cooler 204. Once the clutch is engaged, in operation 818, the engine drive 202 may power the propeller fan 122. In turn, the propeller fan 122 may generate an air flow that is directed from outside the process cooler 204 to inside the process cooler 204 and further directed vertically upwards to pass over the cooling tube 128 and eventually flow out through the louvered opening at the top wall of the enclosure 106. In operation 820, the air flow generated by the propeller fan 122 may cool the gas flowing through the cooler tube 128. The air flowing over the cooling tube 128 may exchange heat with the gas flowing through the cooling tube 128 to cool the gas flowing through the cooling tube 128. For example, heat from the gas in the cooling tube 128 may be transferred to the air flowing over the cooling tube 128, thereby reducing a temperature of the gas flowing through the cooling tube 128. Consequently, the air flowing over the cooling tube 128 may get heated and the heated air may flow out through the louvered opening at the top wall of the process cooler 204.

In operation 822, once the temperature of the gas is reduced, the cooled gas may exit the cooling tube 128 of the process cooler 204 through the other inlet/outlet flange 124. In some embodiments, the other inlet/outlet flange 124 may be coupled to a separator configured on the gooseneck trailer 102. The separator may be adapted to separate liquid matter from the cooled gas and further direct the cooled gas to a gas outlet pipeline and the liquid matter to a separate destination. Further, once the gas is cooled, in operation 824, the process cooler 204 may be switched off. The process ends at operation 826.

In summary, a person of skill in the art will recognize that this detailed description discloses an exemplary portable cooler system having a process cooler mounted to a gooseneck trailer. The process cooler, which can be mounted on the gooseneck trailer and placed within a containment cage, operates as a heat exchanger to cool the temperature of gas passing through the process cooler. The gooseneck trailer has leveling devices typically placed at the front and rear sides of the trailer to permit level installation of the process cooler at a field site.

An engine driver, which can be mounted to the gooseneck trailer and placed outside the containment cage the process cooler, can drive the propeller fan of the process cooler. A fuel vessel and an oil vessel can be mounted to the gooseneck trailer and coupled to the engine driver to maintain fuel and store a lubricant agent (such as oil), respectively. The fuel vessel is typically positioned outside of the containment cage, while the oil vessel is typically positioned inside the containment cage. A separator can be mounted to the gooseneck trailer to support a separation of fluids from an output of the process cooler.

An exemplary process cooler can be implemented by an F-style cooler. A representative process cooler comprises a cooling tube and an inlet flange and an outlet flange coupled to ends of the cooling tube. The cooling tube is typically adapted to carry natural gas. The cooling tube can be positioned at a top portion of the process cooler and arranged in a serpentine manner, wherein the cooling tube is oriented along an axis horizontal to the process cooler. A propeller fan can be coupled to a front portion of the process cooler to provide a forced-air motion across the cooling tube for the heat exchange operation. An exemplary configuration for the propeller fan is a whisper-quiet fan with six fan blades for efficient, reduced noise fan operations. The flow of forced-air motion can be directed in a substantially perpendicular direction within the process cooler for exit at the cooler's top portion and away from the engine driver. A louver can be positioned substantially at the top portion of the process cooler to output forced-air after the heat exchange operation.

The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow. Further, the specification and drawings are to be regarded in an illustrative rather than a restrictive sense.

What is claimed is:

1. A portable cooler system, comprising:
a gooseneck trailer having a plurality of leveling members to permit level installation of the gooseneck trailer at a field site;
a process cooler configured on the gooseneck trailer and placed within an enclosure, the process cooler operable to change a temperature of gaseous matter passing through the process cooler; and
an engine driver configured on the gooseneck trailer and placed outside the enclosure holding the process cooler, the engine driver is coupled to the process cooler and operable to drive a propeller fan of the process cooler

2. The portable cooler system of claim 1, further comprising an oil vessel configured on the gooseneck trailer and operable to provide lubrication for the engine driver, wherein the oil vessel is installed inside the enclosure.

3. The portable cooler system of claim 1, wherein the process cooler is an F-style cooler.

4. The portable cooler system of claim 1, wherein the process cooler comprises:
a cooling tube configured substantially at a top portion of the process cooler and arranged in a serpentine manner, wherein the cooling tube is oriented along an axis horizontal to the process cooler;
an inlet flange coupled to one end of the cooling tube;
an outlet flange coupled to another end of the cooling tube;
the propeller fan coupled to a front portion of the process cooler operable to provide a forced-air motion across the cooling tube for the heat exchange operation; and
a louver configured substantially at the top portion of the process cooler to output the forced-air after the heat-exchange operation.

5. The portable cooler system of claim 1, further comprising a separator arrangement configured on the gooseneck trailer and operable to separate fluids from an output of the process cooler, wherein the separator is coupled to the outlet port of the process cooler.

6. The portable cooler system of claim 4, wherein the propeller fan comprises at least six fan blades.

7. The portable cooler system of claim 4, wherein the cooling tube is adapted to carry natural gas.

8. The portable cooler system of claim 1, wherein the process cooler is adapted to guide a flow of the forced-air motion in a direction that is substantially perpendicular to process cooler and away from the engine driver.

9. The portable cooler system of claim 1, wherein the combined height from the ground, of the process cooler mounted on the gooseneck trailer and the gooseneck trailer is less than 13 feet and 6 inches.

10. The portable cooler system of claim 1, wherein the process cooler and the enclosure is made of aluminum material.

11. The portable cooler system of claim 1, further comprising a solar panel configured on the gooseneck trailer to provide an alternate energy source.

12. The portable cooler system of claim 1, further comprising a fuel vessel configured on the gooseneck trailer and coupled to the engine driver to support an operation of the engine driver.

13. A portable cooler system, comprising:
a trailer having a plurality of leveling members to permit level installation of the trailer at a field site;
a process cooler configured on the trailer and placed within an enclosure, the process cooler operable to change a temperature of gaseous matter passing through the process cooler;
an engine driver configured on the trailer and placed outside the enclosure holding the process cooler, the engine driver is coupled to the process cooler and operable to drive a propeller fan of the process cooler; and
a fuel vessel configured on the trailer and coupled to the engine driver to support an operation of the engine driver.

14. The portable cooler system of claim 13, further comprising a separator arrangement configured on the trailer and operable to separate fluids from an output of the process cooler, wherein the separator is coupled to the outlet port of the process cooler.

15. The portable cooler system of claim 13, further comprising an oil vessel configured on the trailer and operable to provide lubrication for the engine driver, wherein the oil vessel is installed inside the enclosure.

16. The portable cooler system of claim 13, wherein the process cooler is an F-style cooler.

17. A portable cooler system, comprising:
a trailer having a plurality of leveling members to permit level installation of the trailer at a field site;
a process cooler configured on the trailer and placed within an enclosure, the process cooler operable to change a temperature of gaseous matter passing through the process cooler;
an engine driver configured on the trailer and placed outside the enclosure holding the process cooler, the engine driver is coupled to the process cooler and operable to drive a propeller fan of the process cooler;
a fuel vessel configured on the trailer and coupled to the engine driver to support an operation of the engine driver; and
an oil vessel configured on the trailer and operable to provide lubrication for the engine driver, wherein the oil vessel is installed inside the enclosure.

18. The portable cooler system of claim 17, wherein the process cooler comprises:
a cooling tube configured substantially at a top portion of the process cooler and arranged in a serpentine manner, wherein the cooling tube is oriented along an axis horizontal to the process cooler;
an inlet flange coupled to one end of the cooling tube;
an outlet flange coupled to another end of the cooling tube;
the propeller fan coupled to a front portion of the process cooler operable to provide a forced-air motion across the cooling tube for the heat exchange operation; and
a louver configured substantially at the top portion of the process cooler to output the forced-air after the heat-exchange operation.

19. The portable cooler system of claim 17, wherein the combined height from the ground, of the process cooler mounted on the trailer and the trailer is less than 13 feet and 6 inches.

20. The portable cooler system of claim 17, wherein the fuel vessel comprises a mechanism to change the operation of the fuel vessel when a fluid level in the fuel vessel reaches a predetermined fluid level value.
